(19) United States
(12) Patent Application Publication
(10) Pub. No.: US 2007/0065528 A1
(43) Pub. Date: Mar. 22, 2007

(54) Automatic dough cutter for bakery products

(76) Inventor: Samuel Arambula Hernandez, Tonala (MX)

Correspondence Address: FISH & RICHARDSON P.C., P.O. BOX 1022, MINNEAPOLIS, MN, 55440-1022, US

(21) Appl. No.: 11/512,059

(22) Filed: Aug. 29, 2006

(30) Foreign Application Priority Data
Aug. 30, 2005 (MX) PA/A/2005/009227

(51) Int. Cl. B28B 17/00

(52) U.S. Cl. 425/9

(57) ABSTRACT

Systems and processes may include an automated dough divider for bakery products, such as cookies. The dough divider may include a roller. The roller may include a drum mounted on a shaft such that the drum may rotate on the shaft. An external radial surface of the drum may include a plurality of points or stylus stamps to produce holes in a dough sheet. Producing holes in a dough sheet may inhibit the dough from swelling or increasing in volume. The drum may include at least one longitudinal blade, extending along a length of the drum to transversely cut a dough sheet coming from a rolling mill train, and at least one peripheral blade to longitudinally cut the dough sheet. Rectangular and quadrangular sections of dough may be created using the longitudinal blades and peripheral blades.

### CLAIM OF PRIORITY

This application claims priority under 35 USC §119(e) to Mexican Patent Application Serial No. PA/a/2005/009227, filed on Aug. 30, 2005, the entire contents of which are hereby incorporated by reference.

### TECHNICAL FIELD

The present invention relates to the baking industry, more particularly a dough divider for bakery products.

### BACKGROUND

In the baking industry and particularly when making salt cookies, a die-cut roller on a rolling mill train is often used. After dough has passed through a pair of pressing rollers to form a dough sheet, the dough may pass under a die-cut roller, which presses the dough sheet to form a specific engraving or stamp (e.g., die-cut). A die-cut roller may create a square engraving or stamp with attenuating lines defining each square and each square of dough may include a plurality of holes to prevent that the cookie from swelling or increasing in volume.

However, die-cutting a dough sheet does not generate cuts. Since the dough sheet passes directly from the die-cut roller to the baking oven, where a cooked cookie output is obtained in the form of a continuous block, the continuous block of cookie must be cut manually to the required and the desired size. In addition, positioning the cut cookies in desired directions on the conveyor that directs cookies to a wrapping machine, is difficult and tiresome for staff. Manually cutting the cookies, after the cookie block leaves the oven, also may cause partial damage to the cookie, poor presentation of the cookie, and variations in the weight contained in packages. The manual cutting operation thus includes a greater amount of labor, low production volume, and high operating costs.

### SUMMARY

Systems and processes include an automated dough divider for bakery products, such as cookies. The dough divider may cut the cookie prior to baking and may increase the efficiency of operation and the production volumes.

Systems and processes may significantly reduce labor and, therefore, operating costs. Systems and process may also include an automated dough divider that is practical, functional, resistant to damage, and requires little maintenance. Systems and methods may also be used without requiring modifications to production lines already established.

An automated dough divider for bakery products, such as cookies, may include a roller. The roller may include a rotatable shaft and a drum mounted on the shaft so that the drum may rotate on the shaft. An external radial surface of the drum may include a plurality of points or stylus stamps, where the points or stylus stamps produce holes on a dough sheet. Producing holes in the dough sheet may prevent swelling or increases in volume. The drum may include at least one longitudinal blade, disposed on the radial surface of the drum and extending along a length of the drum and capable of transversally cutting a dough sheet from a rolling mill train, and at least one peripheral blade capable of making a longitudinal cut in the dough sheet. Rectangular and quadrangular cookies may be cut from previously stamped dough.

In some implementations, the drum may include more than one longitudinal blade and peripheral blade. Longitudinal blades and peripheral blades may be evenly or unevenly disposed throughout the longitudinal section of a drum. The size of dough cut may depend on the number of longitudinal blades and peripheral blades, which also define the width and the length of the cookies obtained. A number and an arrangement of the longitudinal blades may depend on the required length of cookies and a number and an arrangement of the peripheral blades may depend on the required width of the cookies.

A length and a width of dough cut may be selected based on the weight required in the final cookies to be wrapped. A divider may produce sections of dough of equal or different sizes. For example, dimensions of sections of dough may be either equal or different, depending on the number and the separation of longitudinal blades and peripheral blades on the divider. A larger number of longitudinal blades than peripheral blades may be arranged around the drum of a divider. A length and a width of cookie may be relative.

An arrangement of longitudinal blades and peripheral blades may maintain the alignment, with respect to cross and longitudinal attenuating lines, previously made by a die to execute cuts in the precise and required site (e.g., prevent cuts in sites such as the middle part of a square).

The details of one or more implementations are set forth in the accompanying drawings and the description below. Other features and objects will become be apparent upon from the description, the drawings, and from the claims.

### DESCRIPTION OF DRAWINGS

FIG. 1 illustrates an example of an automated dough divider.

FIG. 2 illustrates an example of an automated dough divider for cutting a dough sheet.

Like reference symbols in the various drawings indicate like elements.

### DETAILED DESCRIPTION OF THE INVENTION

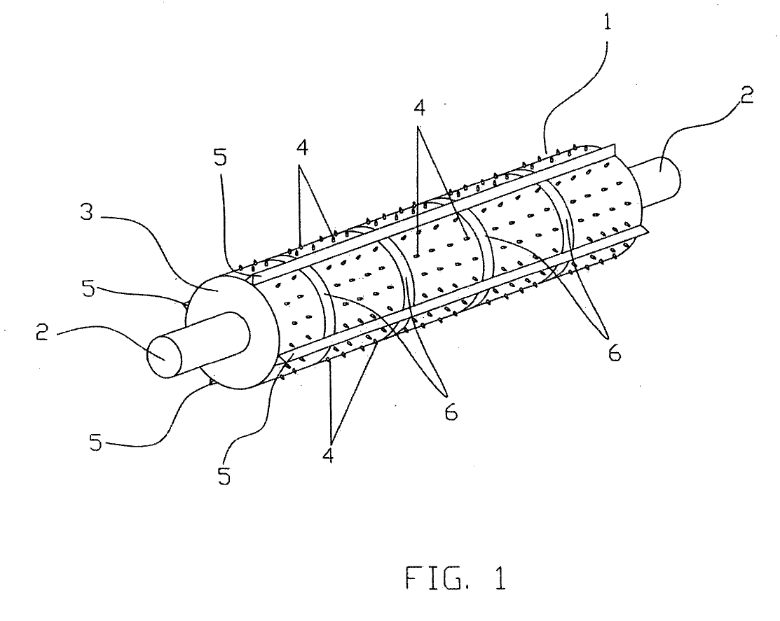

FIG. 1 illustrates an example of an automated dough divider for bakery products, such as cookies. A dough divider may include a roller 1. Roller 1 may include a shaft 2 and a drum 3 mounted on the shaft. Shaft 2 may be an axis of rotation (e.g., a spin axis) for drum 3.

An external radial surface of drum 3 may include a plurality of points or stylus stamps 4. Points 4 may be disposed peripherally on the radial external surface of drum 3. Points 4 may produce holes in a dough sheet, which may inhibit swelling or increases in volume during baking.

Drum 3 may include a plurality of longitudinal blades 5 and peripheral blades 6. Longitudinal blade 5 may be disposed on the radial external surface and extend longitudinally drum 3 and may transversally cut a dough sheet. Peripheral blades 6 may be disposed radially on the radial external surface of drum 3 to make longitudinal cuts to a dough sheet. When drum 3 is rotated and contacts the dough sheet, longitudinal blades 5 and peripheral blades 6 may produce substantially rectangular or quadrangular sections from dough. Longitudinal blades 5 and peripheral blades 6 may produce dough sections of equal or different sizes from a dough sheet.

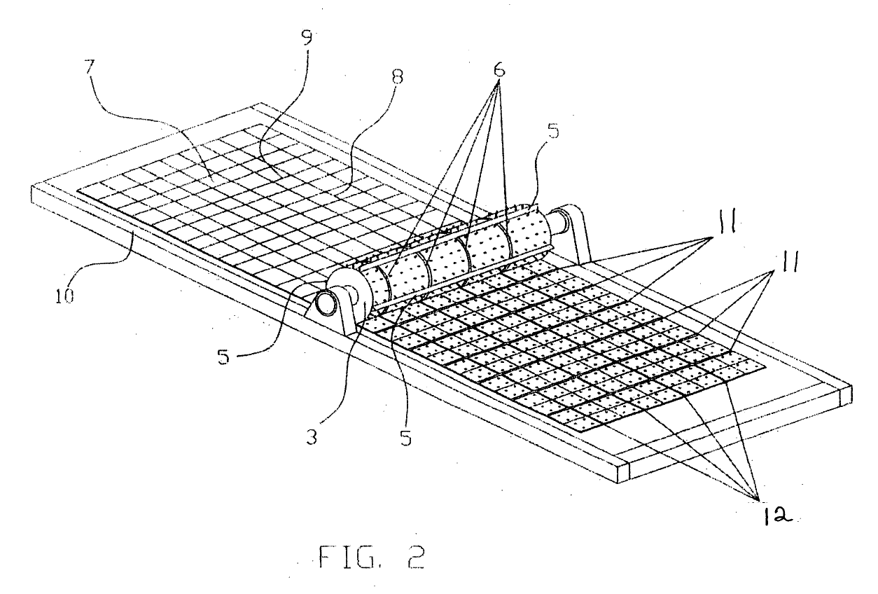

FIG. 2 illustrates an example of an automated dough divider cutting bakery products, such as cookies. FIG. 2 illustrates a dough sheet 7 before and after passing through the dough divider. Dough sheet 7 may pass through a rolling mill train and may be stamped by a die prior to being processed by dough divider. Dough sheet 7 may be stamped by a die to form of a square grid. The die may generate a plurality of longitudinal attenuating lines 8 and cross attenuating lines 9 in dough sheet 7. When dough sheet 7 passes, guided by conveyor 10, under the dough divider, cross cuts 11 produced by longitudinal blades 5 and longitudinal cuts 12 produced by peripheral blades 6 may be made in the attenuating lines 8, 9 of the stamped dough sheet. Sections of dough of different sizes may be obtained based on the desired weight of the cookie.

A number of implementations have been described. Nevertheless, it will be understood that various modifications may be made. Accordingly, other implementations are within the scope of this application.

1-5. (canceled)

6. A system for automatically dividing dough comprising:
a dough divider comprising:
a shaft; and
a drum mounted on the shaft, where the drum is capable of rotating on the shaft; and wherein the drum comprises:
an external surface including a plurality of stylus stamps, wherein the stylus stamps are configured to produce holes in a dough sheet;
at least one longitudinal blade extending along the drum, wherein the longitudinal blade is configured to transversely cut the dough sheet; and
at least one peripheral blade extending along the drum, wherein the peripheral blade is configured to longitudinally cut the dough sheet.

7. The system of claim 6 wherein at least one of the longitudinal blades and at least one of the peripheral blades cut quadrangular sections in the dough sheet during use.

8. The system of claim 6 wherein the dough sheet comprises dough to produce cookies.

9. The system of claim 6 wherein longitudinal blades and peripheral blades are configured to cut a dough sheet along previously stamped attenuating lines.

10. The system of claim 6 further comprising more than one longitudinal blade and more than one peripheral blade, wherein the longitudinal blades and the peripheral blades are distributed along a longitudinal section of the drum.

11. The system of claim 10 wherein the longitudinal blades and the latitudinal blades are arranged in a predetermined areas based on cross attenuating lines and longitudinal attenuating lines of a square grid created by a die when stamping the dough sheet.

12. The system of claim 10 wherein the longitudinal blades are distributed equally or unequally along a longitudinal section of the drum.

13. The system of claim 10 wherein the peripheral blades are distributed equally or unequally along a longitudinal section of the drum.

14. The system of claim 10 wherein at least one of a number or an arrangement of the longitudinal blades on the drum is based on the required length of cookies to be produced.

15. The system of claim 10 wherein at least one of a number or an arrangement of the peripheral blades on the drum is based on the required width of cookies to be produced.

16. The system of claim 10 wherein the longitudinal blades and the peripheral blades are capable of cutting sections of dough of equal or different sizes.

17. The system of claim 6 further comprising a die configured to stamp the dough sheet during use.

18. The system of claim 6 further comprising a die configured to stamp in the dough sheet during use, and wherein at least one of the longitudinal blades and at least one of the peripheral blades cuts the dough sheet on the cross attenuating lines and the longitudinal attenuating lines during use.

19. The system of claim 6 further comprising a conveyor, wherein the dough divider is coupled to the conveyor, and wherein the conveyor moves a dough sheet such that the dough divider can cut the dough sheet during use.

20. A method of dividing dough comprising:
providing a dough sheet on a conveyor
automatically producing holes in the dough sheet;
automatically producing longitudinal cuts in the dough sheet;
automatically producing cross cuts in the dough sheet.

21. The method of claim 20 wherein the dough sheet includes longitudinally attenuating lines stamped by a die, and wherein automatically producing longitudinal cuts in the dough sheet comprises cutting the dough sheet on the longitudinal attenuating lines.

22. The method of claim 21 wherein the dough sheet includes cross attenuating lines stamped by a die, and wherein automatically producing cross cuts in the dough sheet comprises cutting the dough sheet on the cross attenuating lines.

23. The method of claim 21 further comprising stamping a dough sheet with a die.

24. The method of claim 21 wherein automatically producing longitudinal cuts comprises producing longitudinal cuts with a plurality of peripheral blades positioned along a drum of a dough divider, and wherein automatically producing cross cuts comprises producing longitudinal cuts with a plurality of longitudinal blades positioned along a drum of a dough divider.

25. The method of claim 21 wherein automatically producing holes in the dough sheet includes producing holes in the dough sheet with a plurality of stylus stamps positioned on a drum of a dough divider.
